(19) United States
(12) Patent Application Publication
(10) Pub. No.: US 2012/0320341 A1
(43) Pub. Date: Dec. 20, 2012

(54) OPTICAL APPARATUS, PROJECTION APPARATUS AND METHOD OF MANUFACTURING OPTICAL APPARATUS

(76) Inventor: Yoshihisa Aikoh, Kanagawa (JP)

(21) Appl. No.: 13/593,757

(22) Filed: Aug. 24, 2012

(30) Foreign Application Priority Data
Feb. 9, 2011 (JP) 2011-191192

(51) Int. Cl. G03B 21/28; B32B 37/12; G02F 1/00

(52) U.S. Cl. 353/20; 359/237; 156/60

(57) ABSTRACT

There is provided an optical apparatus including a reflection panel unit including a reflection-type optical modulation element, a prism unit including a polarization optical apparatus for outputting a light beam modulated by the reflection-type optical modulation element and a color synthesis prism for receiving, synthesizing and outputting the light beams from the polarization optical apparatus, and a first fixing member for fixing the reflection panel unit to the prism unit, wherein the first fixing member includes a first surface and a second surface intersecting the first surface, and wherein the reflection panel unit and the prism unit include a third surface and a fourth surface to which the first surface and the second surface are adhered via adhesion layers, respectively.

### BACKGROUND

The present technology relates to an optical apparatus, a projection apparatus, and a method of manufacturing an optical apparatus.

As one image display device, a 3-plate projection-type display device (a projection apparatus) is known. The 3-plate projection apparatus separates white light from a light source into three primary colors of RGB (red, green and blue) light beams, inputs the respective colors of light to optical modulation elements provided corresponding to the respective colors of light to be modulated, optically synthesizes the respective modulated colors of light, for example, using a color (light) synthesis prism, and projects the resultant light on a screen. As such a projection apparatus, for example, a projection apparatus using a transmission-type optical modulation element as an optical modulation element or a projection apparatus using a DMD (Digital Micromirror Device) are known. In recent years, a projection apparatus using a reflection-type liquid crystal panel (a reflection panel unit) including a reflection-type optical modulation element that can have higher resolution has also been put into practical use.

In assembling the projection apparatus using a reflection panel unit, a position of the reflection panel unit with respect to, for example, a color synthesis prism is adjusted and the reflection panel unit is fixed so that registration deviation in which respective RGB light beams do not overlap normal correct positions on a screen but deviate therefrom does not occur. For example, solder or adhesive is used to fix the reflection panel unit.

### SUMMARY

However, in a projection apparatus using a reflection panel unit, when the projection apparatus is assembled, the reflection panel unit may not be accurately fixed in a position in which registration deviation does not occur. Further, the position of the once fixed reflection panel unit may deviate because of thermal expansion of constituent parts due to temperature rise in use of the projection apparatus, and registration deviation may occur.

The present disclosure has been made in view of the circumstances described above, and it is desirable to provide an optical apparatus and a projection apparatus in which registration is adjusted with high accuracy for assembly and occurrence of registration deviation caused by temperature rise in use is suppressed. It is also desirable to provide a method of manufacturing such an optical apparatus.

In the light of the foregoing, there is provided an optical apparatus including a fixing member for fixing a reflection panel unit, a prism unit, and a reflection panel unit to a prism unit. The reflection panel unit includes a reflection-type optical modulation element. The prism unit includes a polarization optical apparatus for outputting light modulated by the reflection-type optical modulation element and a color synthesis prism for receiving, synthesizing and outputting the light beams from the polarization optical apparatus. The fixing member includes a first surface and a second surface intersecting the first surface, and the first surface and the second surface are adhered to a third surface of the reflection panel unit and a fourth surface of the prism unit via adhesion layers, respectively.

Further, in the light of the foregoing, there is a projection apparatus including a light source, a separation optical component, an optical apparatus and a projection unit. The separation optical component separates an output light from the light source according to wavelength bands. The optical apparatus modulates the light beams separated by the separation optical component and synthesizes and outputs the modulated light beams. The optical apparatus includes a reflection panel unit, a prism unit, and a fixing member for fixing the reflection panel unit to the prism unit. The reflection panel unit includes a reflection-type optical modulation element. The prism unit includes a polarization optical apparatus for outputting light modulated by the reflection-type optical modulation element, and a color synthesis prism for receiving, synthesizing and outputting the light beams from the polarization optical apparatus. The fixing member includes a first surface and a second surface intersecting the first surface, and the first surface and the second surface are adhered to a third surface of the reflection panel unit and a fourth surface of the prism unit via adhesion layers, respectively. The projection unit of the projection apparatus projection-outputs the output light from the optical apparatus.

Further, the light of the foregoing, there is provided a method of manufacturing an optical apparatus, the method including: preparing a reflection panel unit; preparing a prism unit including a polarization optical apparatus and a color synthesis prism; and fixing the reflection panel unit to the prism unit. When the reflection panel unit is fixed to the prism unit, a fixing member including a first surface and a second surface intersecting the first surface is arranged so that the first surface and the second surface face a third surface of the reflection panel unit and a fourth surface of the prism unit via adhesion layers, respectively. Also, a position of the reflection panel unit with respect to the prism unit is adjusted by moving the reflection panel unit along the first surface or moving the reflection panel unit together with the fixing member along the fourth surface of the prism unit. The reflection panel unit and the prism unit are adhered and fixed using the adhesion layer between the respective surfaces after the position of the reflection panel unit is adjusted.

According to the technology of the disclosure, it is possible to realize an optical apparatus and a projection apparatus in which registration is adjusted with high accuracy for assembly and occurrence of registration deviation caused by temperature rise in use is suppressed.

### BRIEF DESCRIPTION OF THE DRAWINGS

FIG. 1 is a diagram showing a configuration example of a projection apparatus;

FIG. 2 is a perspective view of an example of an optical apparatus;

FIG. 3 is an exploded perspective view (1) of the example of the optical apparatus;

FIG. 4 is an exploded perspective view (2) of the example of the optical apparatus;

FIG. 5 is an enlarged view of primary portions of an example of a reflection panel unit;

FIG. 6 is an illustrative view (1) of a method of fixing a reflection panel unit;

FIG. 7 is an illustrative view (2) of the method of fixing a reflection panel unit;

FIG. 8 is an illustrative view (3) of the method of fixing a reflection panel unit;

FIG. 9 is an illustrative view (4) of the method of fixing a reflection panel unit;

FIG. 10 is an illustrative view (5) of the method of fixing a reflection panel unit;

FIG. 11 is an illustrative view (6) of the method of fixing a reflection panel unit; and

FIG. 12 is an illustrative view (7) of the method of fixing a reflection panel unit.

### DETAILED DESCRIPTION OF THE EMBODIMENTS

Hereinafter, an embodiment of the present technology will be described with reference to the accompanying drawings.

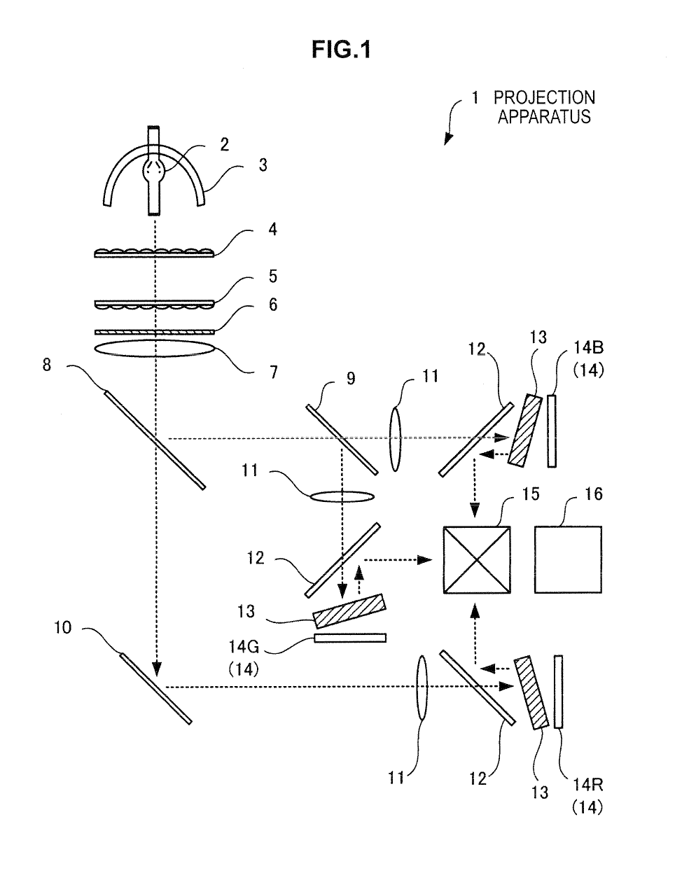

FIG. 1 is a diagram showing a configuration example of a projection apparatus.

The projection apparatus 1 includes a light source 2, a reflector 3, a fly-eye lens 4, a fly-eye lens 5, a polarization beam splitter (a polarization element) 6, a condenser lens 7, a separation and synthesis optical component (including an optical apparatus that will be described later), and a projection lens (a projection unit) 16.

The light source 2 is, for example, an HID (High Intensity Discharge) lamp such as an ultra-high pressure mercury lamp or a metal halide lamp, and outputs white light. The light source 2 is arranged in a focus position of the reflector 3, and the reflector 3 reflects the white light output from the light source 2 to generate substantially parallel light.

The substantially parallel light reflected by the reflector 3 is incident on the fly-eye lens 4 and the fly-eye lens 5, and is output to the polarization beam splitter 6. The fly-eye lens 4 and the fly-eye lens 5 uniformize illuminance of the light to be incident on reflection-type optical modulation elements 14 that will be described later.

The polarization beam splitter 6 aligns a polarization axis of the output light in a predetermined direction. For example, the polarization beam splitter 6 receives light including s-polarized light and p-polarized light and outputs the p-polarized light. The condenser lens 7 receives and condenses the output light of the polarization beam splitter 6. White light output from the condenser lens 7 is incident on the separation and synthesis optical component.

The separation and synthesis optical component includes an optical component (a separation optical component) for separating the incident light from the condenser lens 7 into respective RGB light beams, and spatially modulates and synthesizes the respective colors of light beams separated by the optical component, using the reflection-type optical modulation elements 14 (14R, 14G, 14B) provided to correspond to the light beams. A projection image is formed by output light beams of the separation and synthesis optical component.

The separation and synthesis optical component includes a dichroic mirror 8, a dichroic mirror 9, a mirror (reflection mirror) 10, field lenses 11, reflection-type polarization elements 12, optical compensation elements 13, the reflection-type optical modulation elements 14 (14R, 14G and 14B), and a color synthesis prism 15.

The dichroic mirror 8 and the dichroic mirror 9 selectively transmit or reflect the respective RGB light beams using their wavelength bands. The dichroic mirror 8 transmits light in a red wavelength band and reflects light beams in a green wavelength band and a blue wavelength band. The dichroic mirror 9 transmits the light in the blue wavelength band and reflects the light in the green wavelength band. Accordingly, the white light is separated into three primary colors of RGB. The mirror 10 reflects the light in the red wavelength band. The reflection-type polarization elements 12 polarize the color-separated light beams. The reflection-type optical modulation element 14R spatially modulates the light in the red wavelength band. The reflection-type optical modulation element 14G spatially modulates the light in the green wavelength band. The reflection-type optical modulation element 14B spatially modulates the light in the blue wavelength band.

The light beams color-separated by the dichroic mirror 8 and the dichroic mirror 9 are incident on the field lenses 11 and incident on the reflection-type polarization elements 12, polarized, and incident on the reflection-type optical modulation element 14R, the reflection-type optical modulation element 14G, and the reflection-type optical modulation element 14B, respectively.

The light beams are light-modulated by the reflection-type optical modulation element 14R, the reflection-type optical modulation element 14G, and the reflection-type optical modulation element 14B. The respective reflected RGB light beams are optically compensated (fine adjustment of a phase modulation amount) by the optical compensation elements 13 and then incident on the reflection-type polarization elements 12. The optical compensation elements 13 are provided with a predetermined slope with respect to the reflection-type optical modulation elements 14 in a pair in order to obtain more suitable optical compensation. Each of the RGB light beams incident from the reflection-type optical modulation element 14 to the reflection-type polarization element 12 is partially transmitted through the reflection-type polarization element 12 and returned toward the light source 2 and is partially reflected and incident on the color synthesis prism 15 according to a degree of optical modulation. Further, various materials such as sapphire, crystal and TAC (triacetyl cellulose) may be used as materials of the optical compensation elements 13.

The color synthesis prism 15 transmits the incident light in the green wavelength band and reflects the incident light beams in the red wavelength band and the blue wavelength band toward the projection lens 16. The color synthesis prism 15 is formed, for example, by bonding a plurality of glass prisms (four right-angled isosceles prisms having substantially the same shape) (a prism block), and two of first and second interference filters having a predetermined optical characteristic are formed on a bonding surface of each glass prism. The first interference filter reflects the incident light in the blue wavelength band and transmits the incident light beams in the red wavelength band and the green wavelength. The second interference filter reflects the incident light in the red wavelength band and transmits the incident light beams in the green wavelength band and the blue wavelength band. Accordingly, the respective RGB light beams modulated by the reflection-type optical modulation element 14R, the reflection-type optical modulation element 14G, and the reflection-type optical modulation element 14B are synthesized by the color synthesis prism 15 and incident on a projection lens 16.

The projection lens 16 expands the output light from the separation and synthesis optical component to a predetermined magnification and projects an image to a screen (not shown).

Next, an example of an optical apparatus including the projection apparatus 1 will be described.

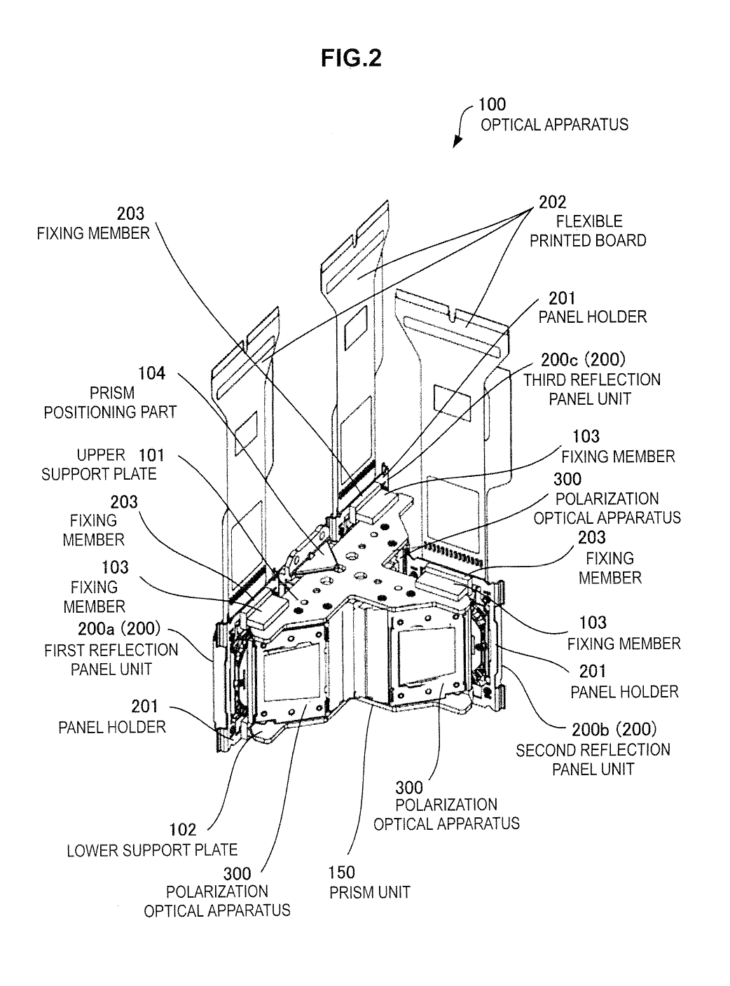

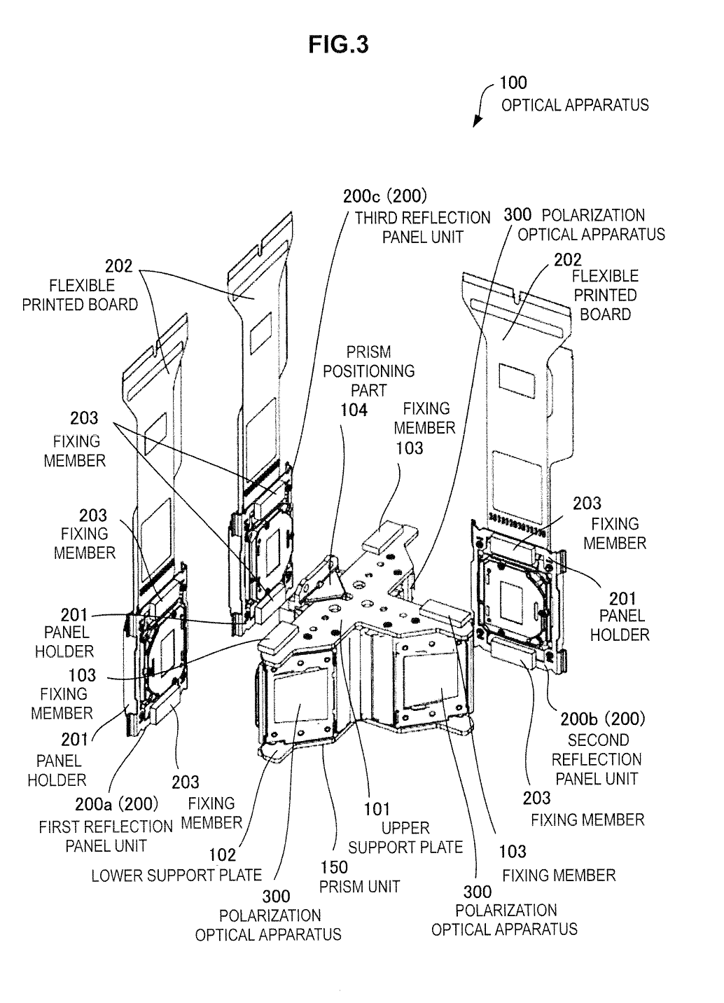

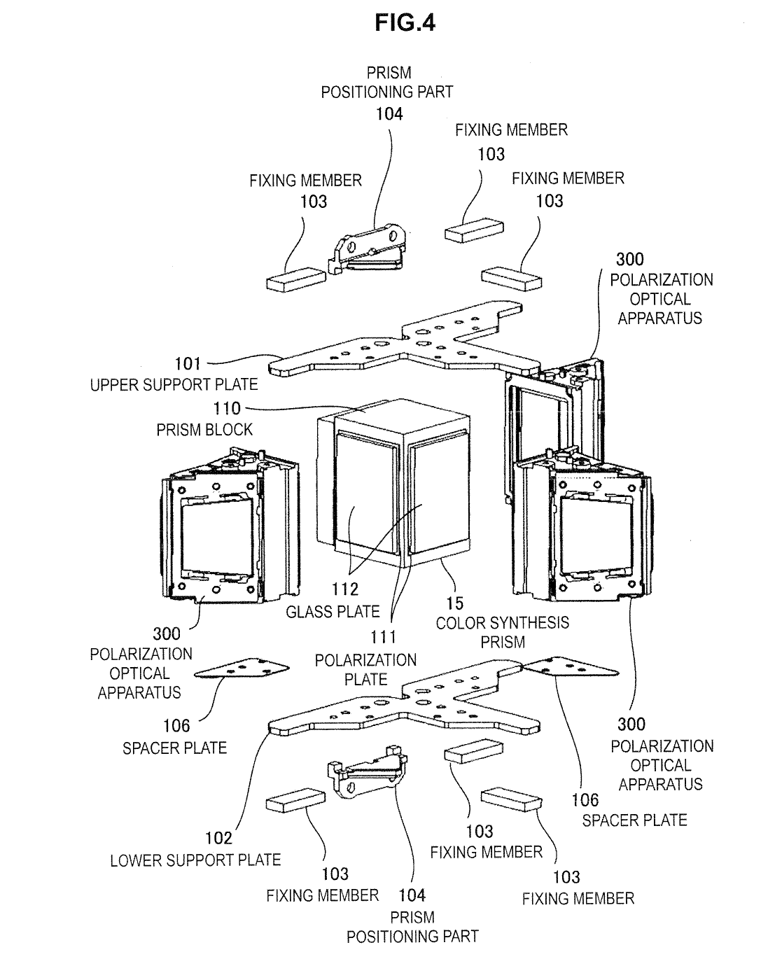

FIG. 2 is a perspective view of an example of the optical apparatus. FIGS. 3 and 4 are exploded perspective views of the example of the optical apparatus.

An optical apparatus 100 constitutes the separation and synthesis optical component of the projection apparatus 1 together with the dichroic mirror 8, the dichroic mirror 9, the mirror (reflection mirror) 10, and the field lenses 11. The optical apparatus 100 spatially modulates the respective color-separated RGB light beams using the reflection-type optical modulation elements 14 and then synthesizes the light beams. A projection image is formed by an output light of the optical apparatus.

The optical apparatus 100 includes a prism unit 150, a first reflection panel unit 200a, a second reflection panel unit 200b, and a third reflection panel unit 200c, as shown in FIGS. 2 and 3.

The first reflection panel unit 200a includes the optical compensation element 13 and the reflection-type optical modulation element 14B and modulates the light in the blue wavelength band. The second reflection panel unit 200b includes the optical compensation element 13 and the reflection-type optical modulation element 14G and modulates the light in the green wavelength band. The third reflection panel unit 200c includes the optical compensation element 13 and the reflection-type optical modulation element 14R and modulates the light in the red wavelength band.

Each of the three reflection panel units 200 (the first reflection panel unit 200a, the second reflection panel unit 200b, and the third reflection panel unit 200c) includes a unit (a light modulation unit 205 that will be described later) that is held in a frame-shaped panel holder 201 and includes the optical compensation element 13 and the reflection-type optical modulation element 14(14B, 14G, 14R). Further, each reflection panel unit 200 includes a flexible printed board 202 electrically connected to the reflection-type optical modulation element 14. Further, each reflection panel unit 200 includes fixing members 203 provided in an upper edge portion and a lower edge portion of the panel holder 201. The fixing member 203, for example, has a rectangular shape. One surface (a side surface) of the fixing member 203 is adhered and fixed in a predetermined position of the predetermined panel holder 201.

Further, several adhesives may be used for adhesion of the fixing member 203 to the panel holder 201. For example, a photo-curable resin such as an ultraviolet (UV) curable resin may be used for the adhesion of the fixing member 203. When such a photo-curable resin is used, a material transparent to light used to cure photo-curable resin is used as the fixing member 203. An example of such a material includes glass.

The prism unit 150 includes the color synthesis prism 15, and three polarization optical apparatuses 300 arranged on three sides (light incident surfaces) around the color synthesis prism 15, as shown in FIG. 4. The color synthesis prism 15 includes a prism block 110 including a plurality of bonded glass prisms, and a polarization plate 111 and a glass plate 112 provided on the surfaces (the light incident surfaces) of the prism block 110 on which the polarization optical apparatuses 300 are arranged. The polarization optical apparatus 300 is configured, for example, with an external form of a substantially triangular prism shape (the inside thereof is hollow). The reflection-type polarization element 12 is provided in a portion corresponding to an inclined surface of the polarization optical apparatus 300. In such a substantially triangularly prismatic polarization optical apparatus 300, among portions corresponding to two intersecting surfaces facing the portion corresponding to the inclined surface, the portion corresponding to the one surface is arranged toward one surface of the color synthesis prism 15, and the reflection panel unit 200 is attached to the portion corresponding to the other surface (FIGS. 2 and 3).

In the prism unit 150, the color synthesis prism 15 and the three polarization optical apparatuses 300 are interposed between an upper support plate 101 and a lower support plate 102, as shown in FIG. 4, and supported by and fixed to the upper support plate 101 and the lower support plate 102. Spacer plates 106 for adjusting positions (heights) of the respective polarization optical apparatuses 300 with respect to the color synthesis prism 15 are arranged between the three polarization optical apparatuses 300 and the lower support plate 102. Further, a positional relationship between the prism unit 150 and the projection lens 16 is determined by a prism positioning part 104.

In the upper support plate 101 and the lower support plate 102, the fixing members 103 are arranged in positions in which the three reflection panel units 200 are attached, as shown in FIGS. 2 to 4. The fixing members 103 are adhered and fixed to surfaces of the upper support plate 101 and the lower support plate 102 and adhered and fixed to the fixing members 203 of the reflection panel units 200. With such fixing members 103, the three reflection panel units 200 are held (fixed) to the prism unit 150.

Further, several adhesives may be used for adhesion of the fixing member 103 to surfaces of the upper support plate 101 and the lower support plate 102 and adhesion of the reflection panel unit 200 to the fixing member 203. For example, a photo-curable resin such as a UV-curable resin may be used for the adhesion of the fixing member 103. When such a photo-curable resin is used, a material transparent to light used to cure the photo-curable resin is used in the fixing member 103. An example of such a material includes glass.

After the prism unit 150 is assembled, adjustment of registration for the reflection panel unit 200 is performed, and the reflection panel unit 200 is fixed to the prism unit 150 by adhering the fixing members 103 to the fixing members 203 and the upper support plate 101 and the lower support plate 102.

However, there is a method of assembling the optical apparatus by fixing the reflection panel units to the prism unit using solder or an adhesive such as a UV-curable resin instead of the fixing members 103 and the fixing members 203. In this method of assembling an optical apparatus, for example, the reflection panel units are fixed to the prism unit as follows.

That is, the reflection panel unit is fixed to the prism unit while adjusting positions in directions (X and Y directions) in a pixel surface of the reflection-type optical modulation element and a focus direction (Z direction) (pixel position adjustment and focus adjustment) so that registration deviation does not occur. In this case, one fixation portion for fixing the reflection panel unit is provided in the prism unit in advance, and the reflection panel unit is subjected to predetermined position adjustment and fixed to the fixation portion using solder or an adhesive.

Here, a certain clearance is necessary between the reflection panel unit and the prism unit so that the reflection panel unit is moved in the X, Y and Z directions upon position adjustment. Solder or an adhesive having a certain thickness (amount) is used to fix the reflection panel unit such that the clearance with the prism unit (fixation portion) necessary for such position adjustment can be secured.

Meanwhile, in a projection apparatus including the optical apparatus after assembly, constituent parts or constituent members of the optical apparatus thermally expand due to temperature rise of the optical apparatus in use according to a configuration of the projection apparatus. Accordingly, a positional relationship between the reflection panel unit and the prism unit (color synthesis prism) may deviate and the registration deviation may occur, as is known.

When the reflection panel unit is fixed to the fixation portion of the prism unit using the solder as described above instead of using the fixing members 103 and the fixing members 203, it is relatively difficult for registration deviation caused by the temperature rise of the optical apparatus in use of the projection apparatus to occur. However, the solder is cooled and solidified after the solder is once melted (registration is adjusted during this time) when the position of the reflection panel unit is adjusted so that the registration deviation does not occur in assembling the optical apparatus. In the adjustment of the registration when the solder is used, it may be relatively easy for the position change of the reflection panel unit to occur before and after such solder cooling, and the positions in the X, Y and Z directions may not all be set with high accuracy and the adjustment of registration may not be performed with high accuracy.

When the reflection panel unit is fixed to the fixation portion of the prism unit using an adhesive as described above instead of using the fixing member 103 and the fixing member 203, it is relatively difficult for the position change of the reflection panel unit in assembling the optical apparatus to occur even when the adhesive is cured, for example, through UV irradiation, unlike the case in which the solder is used for fixing. However, when the adhesive is used, it is relatively easy for registration deviation caused by the temperature rise of the optical apparatus in use of the projection apparatus to occur, and as an amount of the adhesive of the fixation portion increases (as an thickness of the adhesive layer increases), it becomes easier for such registration deviation to occur.

On the other hand, if the fixing members 103 and the fixing members 203 are used, it is possible to adjust the registration with high accuracy and assemble the optical apparatus 100. It is also possible to suppress occurrence of registration deviation caused by temperature rise of the optical apparatus 100 in use of the projection apparatus 1. Hereinafter, this will be described together with an example of a process of assembling the optical apparatus 100.

In assembling the optical apparatus 100, the respective parts as shown in FIG. 3 are prepared and the prism unit 150 is assembled. In this case, first, the polarization optical apparatuses 300 including the reflection-type polarization elements 12 are arranged in predetermined directions on the light incident surfaces of the three sides around the color synthesis prism 15 (the surfaces on which the polarization plate 111 and the glass plate 112 are arranged), respectively. Also, the color synthesis prisms 15 and the polarization optical apparatuses 300 are interposed and fixed between the upper support plate 101 and the lower support plate 102 together with the spacer plates 106. For example, the upper support plate 101 and the lower support plate 102 and the polarization optical apparatuses 300 are fixed by screws. The prism positioning parts 104 are installed in the upper support plate 101 and the lower support plate 102. For example, by doing so, the prism unit 150 of the optical apparatus 100 is assembled.

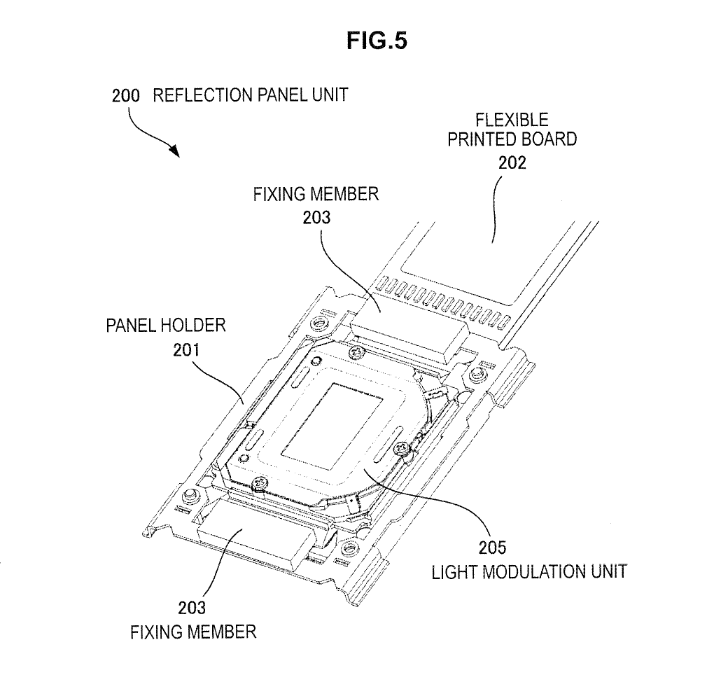

Further, in assembling the optical apparatus 100, the reflection panel units 200 as shown in FIGS. 2, 3, and 5 are prepared together with the prism unit 150. Further, FIG. 5 is an enlarged view of primary portions of an example of the reflection panel unit.

The reflection panel unit 200 includes a light modulation unit 205 including the optical compensation element 13 and the reflection-type optical modulation element 14, as shown in FIG. 5. The light modulation unit 205 is held by the panel holder 201. The flexible printed board 202 is electrically connected to the reflection-type optical modulation element 14 of the light modulation unit 205.

A pair of fixing members 203 are adhered and fixed in a predetermined position on a surface of the panel holder 201 of such an assembly with the light modulation unit 205 interposed therebetween. For example, glass is used as the fixing members 203 and a UV-curable resin is used as the adhesive. The fixing member 203 is arranged in a predetermined position on the surface of the panel holder 201 via the UV-curable resin, and UV irradiation is performed thereon. UV light is transmitted through the fixing member 203 of the glass to cure the UV-curable resin. Accordingly, the reflection panel unit 200 in which the fixing members 203 are adhered and fixed to the panel holder 201 is obtained.

The obtained reflection panel unit 200 is fixed to the prism unit 150 assembled as described above. In this case, the reflection panel unit 200 is subjected to the adjustment of registration and fixed to the prism unit 150 after assembly using the fixing members 203 and the fixing members 103.

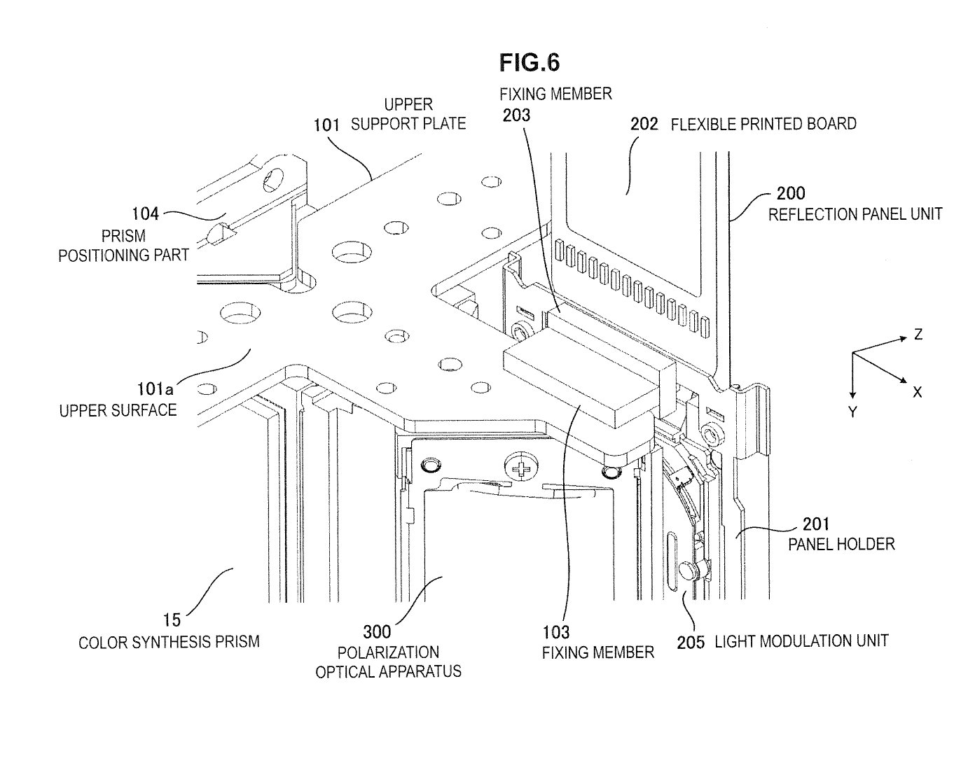

FIGS. 6 to 12 are illustrative views of a method of fixing the reflection panel unit.

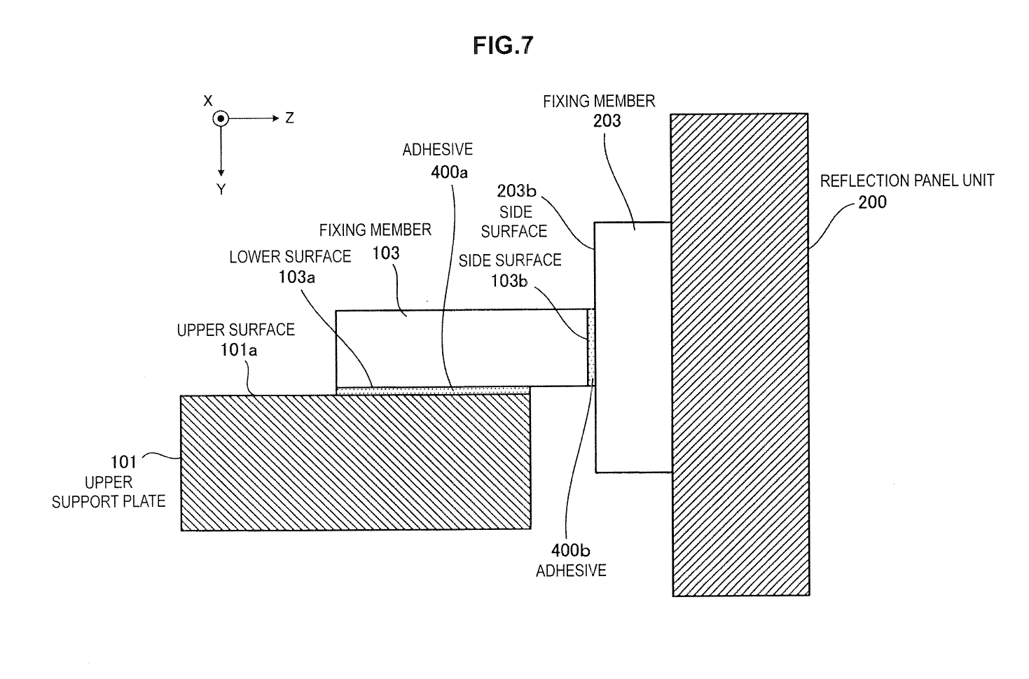

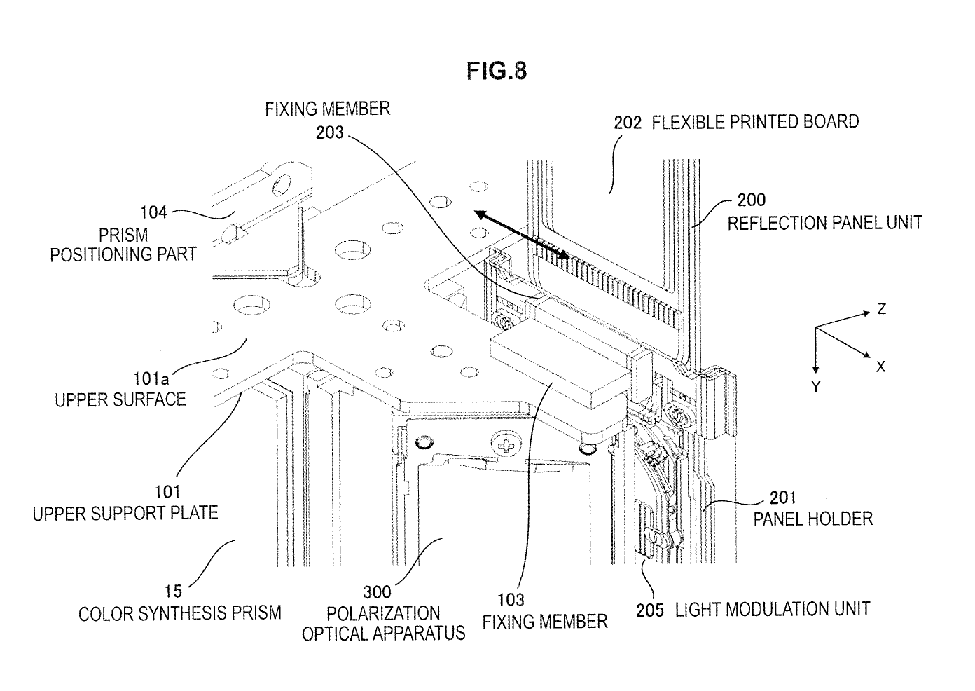

Further, fixation of the reflection panel unit 200 at a side of the upper support plate 101 of the prism unit 150 will be described herein by way of example. FIG. 6 is an enlarged perspective view of fixation portions of the reflection panel unit and the prism unit. FIG. 7 is a schematic view of an example of fixation portion sections of the fixing member, the reflection panel unit, and the upper support plate. FIGS. 8 to 12 are views illustrating behavior of the prism unit in fixation.

When the reflection panel unit 200 is fixed to the prism unit 150, the fixing member 103 is arranged on the fixing member 203 of the reflection panel unit 200 and an upper surface 101a of the upper support plate 101 via an adhesive (an adhesion layer), as shown in FIG. 6. In the fixing member 103, a lower surface 103a thereof is arranged to face the upper surface 101a of the upper support plate 101 via an adhesive 400a, and one side surface 103b thereof is arranged to face one side surface 203b of the fixing member 203 of the reflection panel unit 200 via an adhesive 400b, as shown in FIG. 7. In a step of arranging the fixing member 103, either the adhesive 400a or the adhesive 400b is in an uncured state.

After the fixing member 103 is arranged as described above, adjustment of the position of the reflection panel unit 200 (the adjustment of registration) is performed.

In this case, for example, the position of the reflection panel unit 200 is adjusted in an X direction among directions in the XY plane (in the pixel surface of the reflection-type optical modulation element 14), as shown in FIG. 8. That is, the reflection panel unit 200 and the fixing member 103 are pressed against the adhesive 400b from each other, and the fixing member 103 is pressed against the adhesive 400a. Also, from this state, the reflection panel unit 200 is moved in the X direction so that the fixing member 103 moves along the upper surface 101a of the upper support plate 101 via the adhesive 400a.

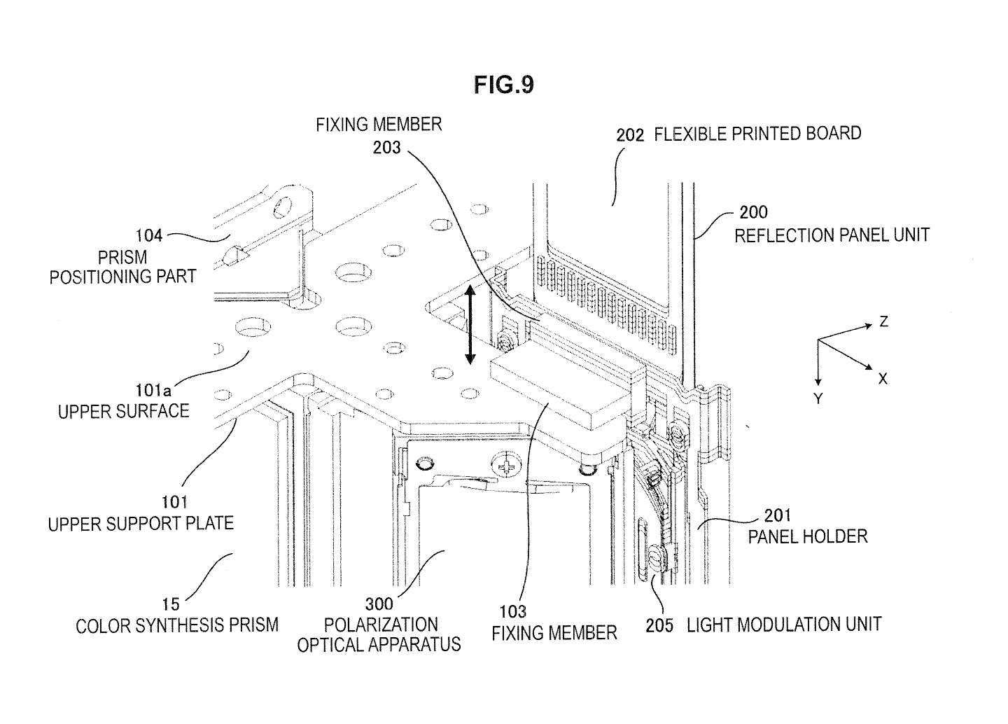

In the Y direction among the directions in the XY plane, the position of the reflection panel unit 200 is adjusted, as shown in FIG. 9. That is, the reflection panel unit 200 and the fixing member 103 are pressed against the adhesive 400b from each other, and the fixing member 103 is pressed against the adhesive 400a. Also, from this state, the reflection panel unit 200 is moved in the Y direction so that the side surface 203b of the fixing member 203 of the reflection panel unit 200 moves along the side surface 103b of the fixing member 103 via the adhesive 400b.

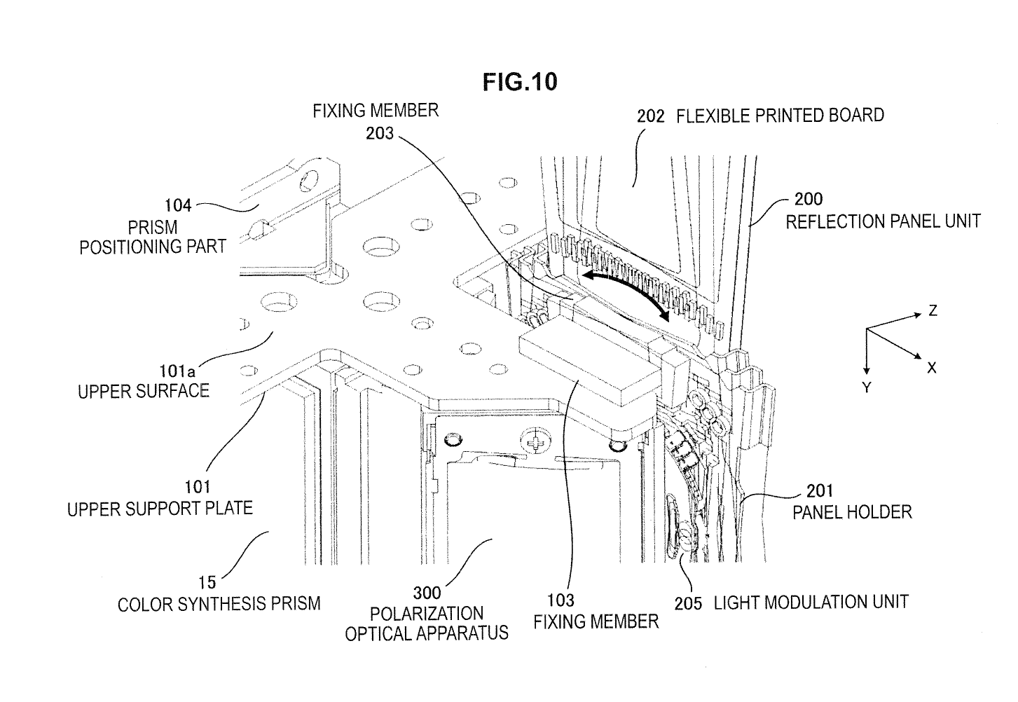

In a rotation direction in the XY plane, the position of the reflection panel unit 200 is adjusted as shown in FIG. 10. That is, the reflection panel unit 200 and the fixing member 103 are pressed against the adhesive 400b from each other, and the fixing member 103 is pressed against the adhesive 400a. Also, from this state, the reflection panel unit 200 is moved in a rotation direction in the XY plane so that the side surface 203b of the fixing member 203 of the reflection panel unit 200 moves along the side surface 103b of the fixing member 103 via the adhesive 400b.

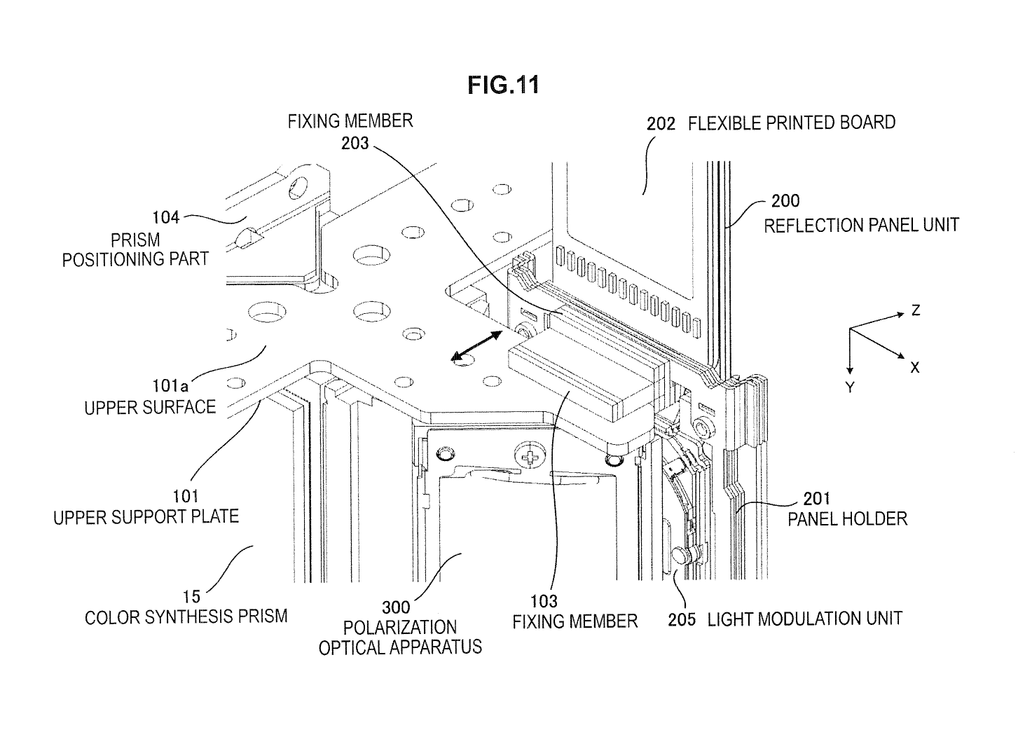

In the Z direction (a focus direction), the position of the reflection panel unit 200 is adjusted as shown in FIG. 11. That is, the reflection panel unit 200 and the fixing member 103 are pressed against the adhesive 400b from each other, and the fixing member 103 is pressed against the adhesive 400a. Also, from this state, the reflection panel unit 200 and the fixing member 103 are moved together in the Z direction so that the fixing member 103 moves along the upper surface 101a of the upper support plate 101 via the adhesive 400a.

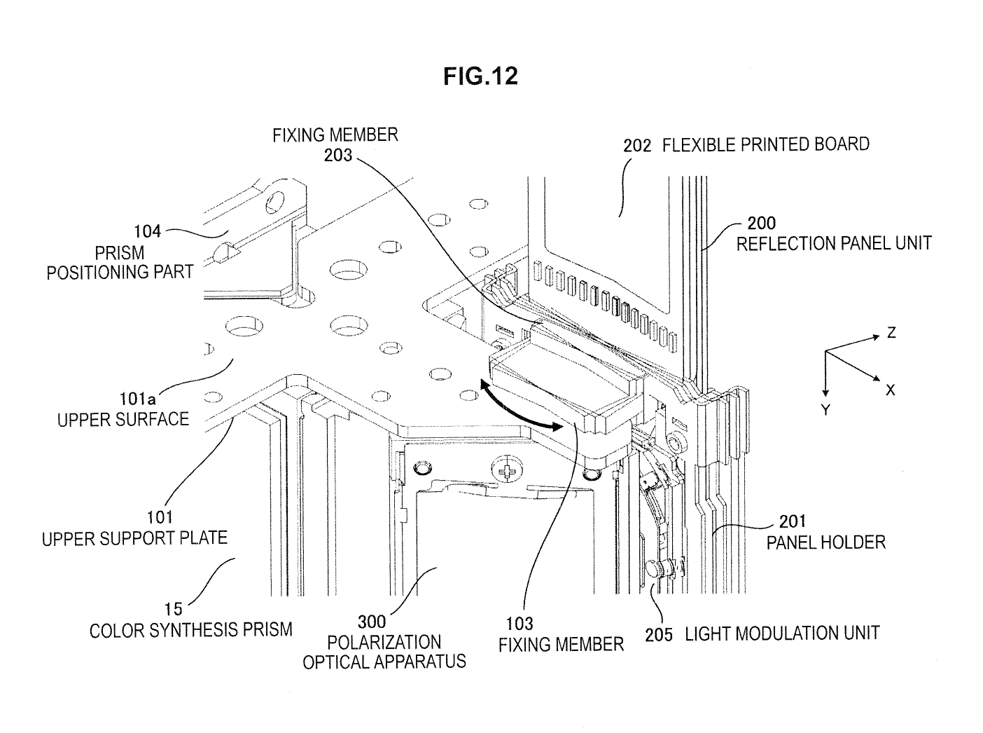

In a rotation direction (a tilt direction) in the XZ plane, the position of the reflection panel unit 200 is adjusted as shown in FIG. 12. That is, the reflection panel unit 200 and the fixing member 103 are pressed against the adhesive 400b from each other, and the fixing member 103 is pressed against the adhesive 400a. Also, from this state, the reflection panel unit 200 and the fixing member 103 are moved together in the rotation direction in the XZ plane so that the fixing member 103 moves along the upper surface 101a of the upper support plate 101 via the adhesive 400a.

With such a method, the position adjustment in the X, Y and Z directions of the reflection panel unit 200, that is, the pixel position adjustment and the focus adjustment (the registration adjustment), can be performed.

Since the adhesive 400a and the adhesive 400b are not cured in a step of adjusting the position of the reflection panel unit 200, the movement of the fixing member 103 along the upper surface 101a of the upper support plate 101 and the movement of the reflection panel unit 200 (the fixing member 203) along the side surface 103b of the fixing member 103 can be smoothly performed. Further, when the fixing member 103 moves along the upper surface 101a of the upper support plate 101 and the reflection panel unit 200 moves along the fixing member 103, the adhesive 400a and the adhesive 400b uniformly thinly spread in a wet state to the lower surface 103a and the side surface 103b of the fixing member 103.

After the position of the reflection panel unit 200 is adjusted as described above, the adjusted position is held and UV irradiation is performed to cure the adhesive 400a and the adhesive 400b. As a material transparent to the UV, such as glass, is used as both the fixing member 103 and the fixing member 203, the adhesive 400a and the adhesive 400b at the two places can be cured together through the UV irradiation.

With the above method, the positions of the reflection panel unit 200 in the X, Y and Z direction are accurately adjusted and fixed to the prism unit 150. Further, while the fixation of the reflection panel unit 200 at a side of the upper support plate 101 has been described herein by way of example, the reflection panel unit 200 is similarly fixed to the prism unit 150 even at a side of the lower support plate 102.

With the above fixing method, the positions in the X and Y directions of the reflection panel unit 200 can be fixed by the adhesive 400b on the side surface 103b of the fixing member 103, and the position in the Z direction of the reflection panel unit 200 can be fixed by the adhesive 400a on the lower surface 103a of the fixing member 103. Thus, in the above fixing method, the part in which the reflection panel unit 200 is fixed to the prism unit 150 is divided in two into the part in which the positions in the X and Y directions are fixed and the part in which the position in the Z direction is fixed.

In this fixing method, it is unnecessary to provide the solder or the adhesive having a certain thickness (amount) according to a clearance necessary for the position adjustment, unlike the case in which the reflection panel unit is fixed to the prism unit at one fixation portion. A thickness of the adhesive 400a that adheres the fixing member 103, the upper support plate 101 and the lower support plate 102 and a thickness of the adhesive 400b that adheres the fixing member 103 and the fixing member 203 of the reflection panel unit 200 can be sufficiently small. Because of this, the position adjustment of the reflection panel unit 200 can be performed with higher accuracy and the adjustment of registration can be performed with higher accuracy as compared to the use of solder or a thick adhesive to fix the reflection panel unit 200. Further, since the thicknesses of the adhesive 400a and the adhesive 400b can be small, the position deviation of the reflection panel unit 200 and accordingly the registration deviation can be effectively suppressed even when a temperature of the optical apparatus 100 rises in use of the projection apparatus 1. For example, the position deviation of the reflection panel unit 200 can be suppressed to be 0.1 mm or less in the respective X, Y and Z directions.

Further, an adhesion area between the prism unit 150 and the reflection panel unit 200 can be a size of the lower surface 103a and the side surface 103b of the fixing member 103 and can be sufficiently greatly secured. Because of this, adhesive strength between the prism unit 150 and the reflection panel unit 200 can be improved.

Further, the glass may be used as the fixing member 103 and the fixing member 203 that fixes the prism unit 150 and the reflection panel unit 200, as described above. The fixing member 103 and the fixing member 203 of glass exhibit a low linear expansion coefficient, similar to the prism block 110. Because of this, even when a temperature of the optical apparatus 100 rises in use of the projection apparatus 1, thermal expansion of the fixing member 103 and the fixing member 203 can be suppressed and the position deviation of the reflection panel unit 200 and accordingly the registration deviation can be effectively suppressed.

Further, in the above description, the fixing member 203 adhered to the fixing member 103 via the adhesive 400b is provided in the reflection panel unit 200. In addition, if there is a flat area in an area of the reflection panel unit 200 facing the side surface 103b of the fixing member 103, such fixation may be performed without providing the fixing member 203.

Further, as described above, the fixation of the prism unit 150 and the reflection panel unit 200 using the fixing member 103 is performed on the lower surface 103a and the side surface 103b of the fixing member 103. Accordingly, as an area of the lower surface 103a and an area of the side surface 103b increase, an adhesion area between the prism unit 150 and the reflection panel unit 200 can increase. While the fixing member 103 having a certain size and a rectangular shape has been illustrated in the above description, the size and the shape may be set in view of such an adhesion area. Similarly, a size and a shape of the fixing member 203 provided in the reflection panel unit 200 may be set in view of the adhesion area with the fixing member 103.

Additionally, the present technology may also be configured as below.

(1) An optical apparatus including:

a reflection panel unit including a reflection-type optical modulation element;

a prism unit including a polarization optical apparatus for outputting a light beam modulated by the reflection-type optical modulation element and a color synthesis prism for receiving, synthesizing and outputting the light beams from the polarization optical apparatus; and

a first fixing member for fixing the reflection panel unit to the prism unit,

wherein the first fixing member includes a first surface and a second surface intersecting the first surface, and

wherein the reflection panel unit and the prism unit include a third surface and a fourth surface to which the first surface and the second surface are adhered via adhesion layers, respectively.

(2) The optical apparatus according to (1), wherein

a photo-curable resin is used for the adhesion layer, and

a material transparent to light that cures the adhesion layer is used for the first fixing member.

(3) The optical apparatus according to (1) or (2), wherein

glass is used for the first fixing member.

(4) The optical apparatus according to any one of (1) to (3), wherein

the reflection panel unit includes a second fixing member having the third surface.

(5) The optical apparatus according to (4), wherein

glass is used for the second fixing member.

(6) The optical apparatus according to any one of (1) to (5), wherein

the prism unit supports the polarization optical apparatus and the color synthesis prism, and includes a support plate having the fourth surface.

(7) A projection apparatus including:

a light source;

a separation optical component for separating an output light beam from the light source according to wavelength bands;

an optical apparatus for modulating the light beams separated by the separation optical component and synthesizing and outputting the modulated light beams; and

a projection unit for projection-outputting the output light beam from the optical apparatus,

wherein the optical apparatus includes
a reflection panel unit including a reflection-type optical modulation element,
a prism unit including a polarization optical apparatus for outputting a light beam modulated by the reflection-type optical modulation element and a color synthesis prism for receiving, synthesizing and outputting the light beams from the polarization optical apparatus, and
a fixing member for fixing the reflection panel unit to the prism unit,
wherein the fixing member includes a first surface and a second surface intersecting the first surface, and

wherein the reflection panel unit and the prism unit include a third surface and a fourth surface to which the first surface and the second surface are adhered via adhesion layers, respectively.

(8) A method of manufacturing an optical apparatus, the method including:

preparing a reflection panel unit including a reflection-type optical modulation element;

preparing a prism unit including a polarization optical apparatus for outputting a light beam modulated by the reflection-type optical modulation element and a color synthesis prism for receiving, synthesizing and outputting the light beams from the polarization optical apparatus;

arranging a fixing member including a first surface and a second surface intersecting the first surface so that the first surface and the second surface face a third surface of the reflection panel unit and a fourth surface of the prism unit via adhesion layers, respectively;

adjusting a position of the reflection panel unit with respect to the prism unit by moving the reflection panel unit along the first surface or moving the reflection panel unit together with the fixing member along the fourth surface; and

adhering and fixing the reflection panel unit and the prism unit using the adhesion layer after adjusting the position of the reflection panel unit.

Further, several changes may be made to the above-described embodiments without departing from the gist of the embodiments.

Further, a number of modifications and alterations may be made to the above-described embodiments by those skilled in the art, and the embodiments are not limited to the exact described configurations and application examples.

The present disclosure contains subject matter related to that disclosed in Japanese Priority Patent Application JP 2011-191192 filed in the Japan Patent Office on Sep. 2, 2011, the entire content of which is hereby incorporated by reference.

What is claimed is:

1. An optical apparatus comprising:
a reflection panel unit including a reflection-type optical modulation element;
a prism unit including a polarization optical apparatus for outputting a light beam modulated by the reflection-type optical modulation element and a color synthesis prism for receiving, synthesizing and outputting the light beams from the polarization optical apparatus; and
a first fixing member for fixing the reflection panel unit to the prism unit,
wherein the first fixing member includes a first surface and a second surface intersecting the first surface, and
wherein the reflection panel unit and the prism unit include a third surface and a fourth surface to which the first surface and the second surface are adhered via adhesion layers, respectively.

2. The optical apparatus according to claim 1, wherein
a photo-curable resin is used for the adhesion layer, and
a material transparent to light that cures the adhesion layer is used for the first fixing member.

3. The optical apparatus according to claim 1, wherein
glass is used for the first fixing member.

4. The optical apparatus according to claim 1, wherein
the reflection panel unit includes a second fixing member having the third surface.

5. The optical apparatus according to claim 4, wherein
glass is used for the second fixing member.

6. The optical apparatus according to claim 1, wherein
the prism unit supports the polarization optical apparatus and the color synthesis prism, and includes a support plate having the fourth surface.

7. A projection apparatus comprising:
a light source;
a separation optical component for separating an output light beam from the light source according to wavelength bands;
an optical apparatus for modulating the light beams separated by the separation optical component and synthesizing and outputting the modulated light beams; and
a projection unit for projection-outputting the output light beam from the optical apparatus,
wherein the optical apparatus includes
a reflection panel unit including a reflection-type optical modulation element,
a prism unit including a polarization optical apparatus for outputting a light beam modulated by the reflection-type optical modulation element and a color synthesis prism for receiving, synthesizing and outputting the light beams from the polarization optical apparatus, and
a fixing member for fixing the reflection panel unit to the prism unit,
wherein the fixing member includes a first surface and a second surface intersecting the first surface, and
wherein the reflection panel unit and the prism unit include a third surface and a fourth surface to which the first surface and the second surface are adhered via adhesion layers, respectively.

8. A method of manufacturing an optical apparatus, the method comprising:
preparing a reflection panel unit including a reflection-type optical modulation element;
preparing a prism unit including a polarization optical apparatus for outputting a light beam modulated by the reflection-type optical modulation element and a color synthesis prism for receiving, synthesizing and outputting the light beams from the polarization optical apparatus;
arranging a fixing member including a first surface and a second surface intersecting the first surface so that the first surface and the second surface face a third surface of the reflection panel unit and a fourth surface of the prism unit via adhesion layers, respectively;
adjusting a position of the reflection panel unit with respect to the prism unit by moving the reflection panel unit along the first surface or moving the reflection panel unit together with the fixing member along the fourth surface; and
adhering and fixing the reflection panel unit and the prism unit using the adhesion layer after adjusting the position of the reflection panel unit.
